(19) United States
(12) Patent Application Publication
(10) Pub. No.: US 2026/0264888 A1
(43) Pub. Date: Sep. 10, 2026

(54) Systems and Methods for Deploying Launch Vehicle Landing Equipment

(71) Applicant: Relativity Space, Inc., Long Beach, CA (US)

(72) Inventors: Kyle Thompson, Long Beach, CA (US); Sophia Gnehm, Long Beach, CA (US); Matthew Khajehpour, Long Beach, CA (US); Ryan Craig, Long Beach, CA (US); Cameron Close, Long Beach, CA (US); Benjamin Champion, Long Beach, CA (US); Vetri Chandrasekaran, Long Beach, CA (US)

(73) Assignee: Relativity Space, Inc., Long Beach, CA (US)

(21) Appl. No.: 19/559,850

(22) Filed: Mar. 6, 2026

Related U.S. Application Data
(60) Provisional application No. 63/768,095, filed on Mar. 6, 2025.
(60) Provisional application No. 63/768,142, filed on Mar. 6, 2025.

(51) Int. Cl. B64G 1/40; B64G 1/62

(52) U.S. Cl. CPC B64G 1/4022; B64G 1/401; B64G 1/4021; B64G 1/625

(57) ABSTRACT

Systems, methods, structures and configuration thereof, for launch vehicle equipment. Specifically systems and methods of transitioning landing legs from stowed to a deployed configuration and structures thereof. Systems, methods, and configurations for an active landing system are provided. Specifically, systems and methods of transitioning landing legs from a stowed, deployed, and locked configuration and structures thereof. More particularly, systems, methods, structures, and configuration for fueling launch vehicles with pressure vessels and propellant tanks are provided. Specifically, these systems and methods focus on utilizing pressure vessels and propellant tanks for the efficient storage and management of propellants and pressurant gas to optimize thermodynamics and thermal exchanges with the surrounding environment, thereby improving storage capabilities and enhancing overall performance.

### CROSS-REFERENCE RELATED APPLICATIONS

The current application claims priority to U.S. Provisional Application No. 63/768,095, filed Mar. 6, 2025, and Provisional Application No. 63/768,142, filed Mar. 6, 2025, the disclosures of which are incorporated herein by reference in their entireties.

### FIELD OF THE INVENTION

This disclosure generally refers to systems and methods for launch vehicle equipment and configurations. Specifically, this disclosure relates to systems and methods for deploying launch vehicle landing equipment, including the structures and configurations thereof, for the safe and efficient landing of launch vehicles. This disclosure refers to systems and methods for pressurizing propellant tanks, and structures and configurations therefore.

### BACKGROUND

Reusable launch vehicles are complex machines that rely on carefully-traded assemblies of launch vehicle engines, vehicle structures, propellant tanks, payload adaptors, and re-use hardware to launch payloads into orbit and return a first stage for later re-use. Propellant tanks typically include fuel and oxidizer tanks in each stage, and re-use hardware typically includes grid fins and landing legs on the first stage.

Commercial launch vehicle technology has increasingly prioritized launch vehicle reusability. In particular, substantial efforts have been made to optimize the recovery of the first stage of a launch vehicle. The ability to safely recover and refurbish core launch vehicle components after launch enables operators to substantially reduce overall mission costs, making space access more economical and sustainable. One of the important systems that facilitates the recovery of launch vehicle stages is the inclusion of landing mechanisms in the launch vehicle design. The landing mechanisms are important for stabilizing the booster during landing and touchdown.

A widely adopted landing mechanism configuration is the integration of landing legs. Landing legs are designed to be stowed within the launch vehicle's structure or positioned against its outer body during flight. Stowage of the landing legs is beneficial during ascent, to minimize aerodynamic drag. In many configurations, stowage of the landing legs also can more efficiently distribute the vehicle mass, and thereby further enhance the launch vehicle efficiency. As the launch vehicle approaches landing during descent, the landing legs can be extended. The extended landing legs provide a stable platform that can support the weight of the booster upon contact with the landing pad or drone ship.

The successful operation of the landing system depends on the intricate integration of the landing system with the launch vehicle's overall architecture. Many landing system configurations require specialized hardware, sophisticated control algorithms, and redundancy measures. Each of the landing system components is configured to work reliably and work in perfect concert with each other and the other launch vehicle systems to ensure reliable operation. Furthermore, the landing system has to perform flawlessly even in the extreme conditions experienced during flight. As a result, potential hardware failures, such as valve malfunctions, gear issues, mechanical binding, and power loss, pose substantial risks that could jeopardize a safe touchdown.

Consequently, the industry is in need of enhanced landing systems that can improve the reliability and efficiency of launch vehicle landings. System improvements not only bolster reusability but also advance the overall safety and effectiveness of commercial spaceflight operations.

Composite Overwrapped Pressure Vessels (COPVs) are high-strength, lightweight containers designed to store gases under extremely high pressures. They typically consist of a thin liner that is often made of metal or plastic reinforced by layers of composite fibers such as carbon or Kevlar bound together by resins. The COPV construction ensures that the liner provides a tight seal against leakage, and has the structural integrity to withstand the loads it is exposed to. COPVs are crucial components in launch vehicles, enabling a superior strength-to-weight ratio compared to alternative configurations, which is crucial in aerospace applications where every kilogram must be designed for.

COPVs are commonly employed in launch vehicles to store pressurant gases such as helium that are used to maintain propellant tank pressure. As a vehicle consumes its fuel and oxidizer, the COPV gas can replace the expended fuel and oxidizer in the propellant tank to maintain a more consistent pressure. Vehicles typically carry propellants such as liquid oxygen (LOX), liquid hydrogen (LH₂), kerosene (RP-1), or hypergolic mixtures, all of which need precise tank pressures to ensure the steady flow of the propellants into the engines. Because propellant tanks can empty quickly or experience large temperature swings, a pressurizing gas is introduced to replace the volume left by the consumed propellant, preventing tank collapse and keeping the supply stable. COPVs are often ideal for storing the necessary replacement gas because they can contain very high pressures while adding only minimal mass to the vehicle, thereby maximizing payload capability and reducing launch costs.

### SUMMARY OF THE INVENTION

Systems and methods in accordance with some embodiments of the invention are directed to systems, methods and structure for pressurizing launch vehicles with pressurant COPVs submerged in propellant tanks.

In some embodiments, the techniques described herein relate to a launch vehicle storage system including: a plurality of propellant tanks; at least one pressurant tank disposed within one of the plurality of propellant tanks; a plurality of fluid passageways interconnecting the plurality of propellant tanks and the at least one pressurant tank; wherein at least one propellant tank is an oxidizer tank and at least one propellant tank is a fuel tank, and at least one pressurant tank is disposed within the fuel tank; and wherein a fuel tank and the pressurant tank are configured so that a fuel disposed in the fuel tank transfers heat from the pressurant tank.

In some embodiments, the techniques described herein relate to a launch vehicle storage system further configured so that the heat transferred from the pressurant tank cools a pressurant disposed in the pressurant tank.

In some embodiments, the techniques described herein relate to a launch vehicle storage system further including a plurality of valves in fluid communication with the plurality of fluid passageways and configured to distribute a pressurant from the pressurant tank proximal to a heat source heating the pressurant.

In some embodiments, the techniques described herein relate to a launch vehicle storage system wherein the pressurant is distributed to at least one of the plurality of propellant tanks.

In some embodiments, the techniques described herein relate to a launch vehicle storage system wherein the fuel is a cryogenic fuel.

In some embodiments, the techniques described herein relate to a launch vehicle storage system wherein the fuel is saturated or densified.

In some embodiments, the techniques described herein relate to a launch vehicle storage system wherein an oxidizer disposed in the oxidizer tank is saturated or densified.

In some embodiments, the techniques described herein relate to a method for fueling a launch vehicle storage system including: loading propellants into a launch vehicle storage system; wherein the launch vehicle storage system includes a plurality of propellant tanks, at least one pressurant tank disposed within one of the plurality of propellant tanks, and a plurality of fluid passageways interconnecting the plurality of propellant tanks and the at least one pressurant tank; wherein at least one propellant tank is an oxidizer tank, at least one propellant tank is a fuel tank, and at least one pressurant tank is disposed within the fuel tank such that when a fuel is disposed in the fuel tank the fuel transfers heat from the pressurant tank; introducing an oxidizer into the oxidizer tank; introducing a pressurant into the pressurant tank; introducing a fuel into the fuel tank so that the at least one pressurant tank is surrounded by the fuel allowing the fuel to absorb thermal energy from the at least one pressurant tank and thereby regulating the temperature within the pressurant tank; and distributing the pressurant between the propellant tanks and the pressurant tank via the plurality of fluid passageways for launch vehicle operation.

In some embodiments, the techniques described herein relate to a method for fueling a launch vehicle storage system, including: loading a first stage system with a first oxidizer at a first oxidizer temperature and a first fuel at a first fuel temperature; loading a second stage system with a second oxidizer at a second oxidizer temperature and a second fuel at a second fuel temperature; wherein the first stage system includes a plurality of first stage propellant tanks and at least one first stage pressurant tank disposed within one of the plurality of propellant tanks; wherein the second stage system includes a plurality of second stage propellant tanks, at least one second stage pressurant tank disposed within one of the plurality of propellant tanks, and a plurality of fluid passageways interconnecting the plurality of second stage propellant tanks and the at least one second stage pressurant tank; wherein at least one second stage propellant tank is an oxidizer tank, at least one second stage propellant tank is a fuel tank, and the at least one second stage pressurant tank is disposed within the fuel tank such that the fuel transfers heat from the pressurant tank; introducing the first oxidizer and the second oxidizer into the oxidizer tanks; and introducing the first fuel and the second fuel into the fuel tanks so that the at least one second stage pressurant tank is surrounded by the fuel in at least one of the second stage fuel tanks.

In some embodiments, the techniques described herein relate to a method for fueling a launch vehicle storage system, wherein a heat transfer rate in the fuel tank is lower than a heat transfer rate in the oxidizer tank.

In some embodiments, the techniques described herein relate to a launch vehicle storage system including: a plurality of propellant tanks; a plurality of pressurant tanks disposed within at least two of the plurality of propellant tanks; a plurality of fluid passageways interconnecting the plurality of propellant tanks and the plurality of pressurant tanks; wherein at least one propellant tank is an oxidizer tank and at least one propellant tank is a fuel tank, and at least one pressurant tank is disposed within the oxidizer tank, and at least one pressurant tank is disposed within the fuel tank; wherein the oxidizer tank and the pressurant tank within the oxidizer tank are configured so that an oxidizer disposed in the oxidizer tank transfers heat from the pressurant tank. and wherein the fuel tank and the pressurant tank within the fuel tank are configured so that a fuel disposed in the fuel tank transfers heat from the pressurant tank.

In some embodiments, the techniques described herein relate to a launch vehicle landing system including: a plurality of landing legs disposed on a launch vehicle body configured to transition from a stowed configuration to a deployed configuration; wherein each of the plurality of landing legs is configured to extend distally from an axis of the launch vehicle body; wherein each of the plurality of landing legs includes a slide, a track, a linkage, a landing foot, a plurality of pivot points and a biasing mechanism; wherein the at least one biasing mechanism is configured to exert a force on at least one of the plurality of landing legs; wherein the slide is configured to traverse from a first end of the track to a second end of the track; wherein the slide mechanism is pivotally coupled to the linkage, the linkage is pivotally coupled to the landing foot and the landing foot is pivotally coupled to the launch vehicle body and traversing the slide mechanism from the first end of the track to the second end of the track transitions the plurality of landing leg from the stowed configuration to the deployed configuration; wherein the linkage and landing foot pivot at pivot points disposed on the slide mechanism and the launch vehicle body.

In some embodiments, the techniques described herein relate to a launch vehicle landing system, wherein in the deployed configuration a catch mechanism secures the plurality of landing legs in an orientation.

In some embodiments, the techniques described herein relate to a launch vehicle landing system, wherein the slide mechanism further includes a low-friction bearing or blocks.

In some embodiments, the techniques described herein relate to a launch vehicle landing system, wherein the low-friction bearing or blocks include bearings.

In some embodiments, the techniques described herein relate to a launch vehicle landing system, further including at least one seal disposed proximal to the linkage.

In some embodiments, the techniques described herein relate to a launch vehicle landing system, further including at least one shroud disposed proximal to each of the plurality of landing legs.

In some embodiments, the techniques described herein relate to a launch vehicle landing system, wherein the at least one shroud is configured to augment each of the landing legs aerodynamics.

In some embodiments, the techniques described herein relate to a launch vehicle landing system, wherein the linkage is configured to augment aerodynamics of the launch vehicle body.

In some embodiments, the techniques described herein relate to a method of deploying a landing system including: releasing a plurality of landing legs disposed on a launch vehicle body, the plurality of landing legs each including a slide, a track, a linkage, a landing foot, a plurality of pivot points, at least one hold down release mechanism and at least one biasing mechanism; wherein releasing the plurality of landing legs induces the at least one biasing mechanism to exert a force on each of the plurality of landing legs; extending the plurality of landing leg distal from the launch vehicle body; sliding the slide from a first end of the track to a second end of the track; pivoting the linkage and landing foot at pivot points relative to the slide and the launch vehicle body; transitioning the plurality of landing legs from a stowed position to a deployed position; wherein the slide is pivotally coupled to the linkage, the linkage is pivotally coupled to the landing foot and the landing foot is pivotally coupled to the launch vehicle body and traversing the slide from the first end of the track to the second end of the track transitions the plurality of landing leg from the stowed position to the deployed position; and locking the plurality of legs in the deployed position.

Additional embodiments and features are set forth in component in the description that follows, and in component will become apparent to those skilled in the art upon examination of the specification or may be learned by the practice of the disclosure. A further understanding of the nature and advantages of the present disclosure may be realized by reference to the remaining portions of the specification and the drawings, which forms a component of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIG. 1 illustrates a launch vehicle with propellant tanks and re-use hardware in accordance with some embodiments.

FIG. 2 illustrates a schematic of the stages of a launch vehicle flight in accordance with some embodiments.

FIGS. 3A and 3B illustrate the deployment of a landing system in accordance with many embodiments.

FIGS. 3C to 3G illustrate views of landing system components in accordance with many embodiments.

FIGS. 4A to 4D illustrates views of landing system components in accordance with many embodiments.

FIGS. 5A to 6B illustrate schematics of launch vehicle propellant tank configurations in accordance with some embodiments.

### DETAILED DESCRIPTION OF THE INVENTION

It will be understood that the components of the embodiments, as generally described herein and illustrated in the appended figures, may be arranged and designed in a variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

The present disclosure may be embodied in other specific forms without departing from its spirit or principal characteristics. The described embodiments are to be considered in all respects as illustrative and not restrictive.

Reference throughout this specification to features, advantages, or similar language does not imply that all of the features and advantages that may be realized with the present disclosure are intended to be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages and similar language throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may but do not necessarily, all refer to the same embodiment.

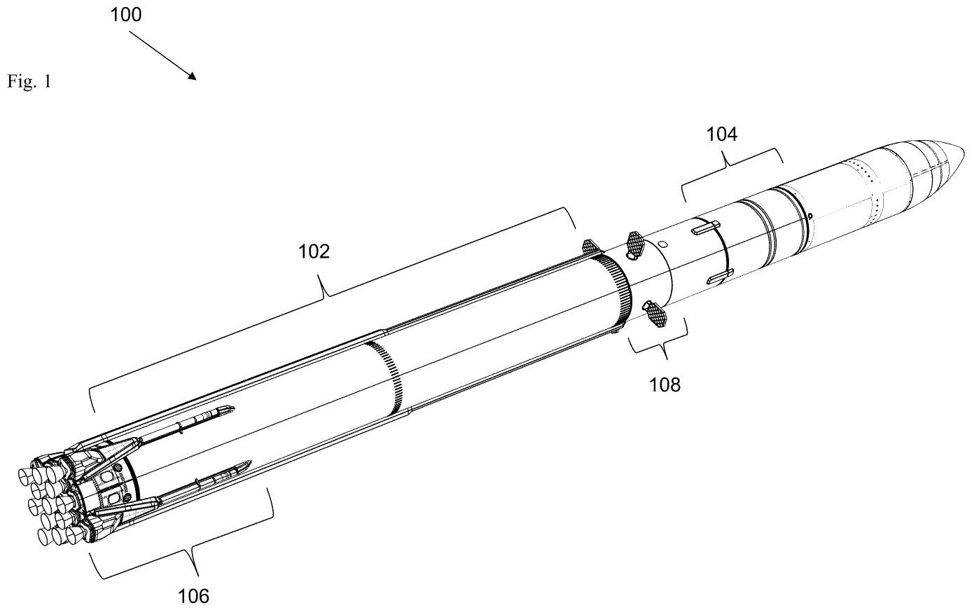

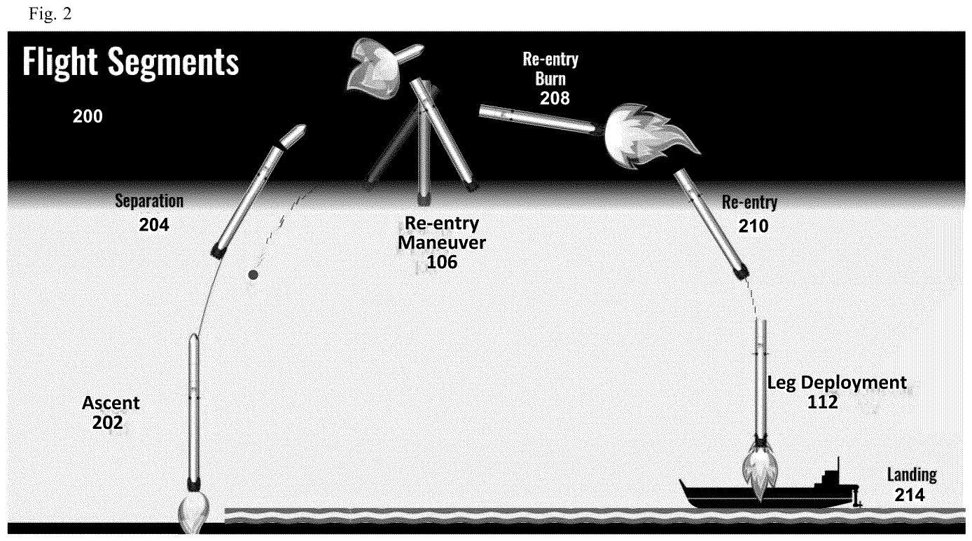

Turning now to the Figures, FIG. 1 depicts partially-reusable launch vehicle 100. Launch vehicle 100 features launch vehicle engines, vehicle structures, propellant tanks, a payload adapter, and re-use hardware to launch payloads into orbit and return its first stage for later reuse. In some embodiments, launch vehicle 100 includes a reusable first stage and an expendable second stage. The reusable first stage includes propellant tanks 102 that extend along most of the length of the first stage, between an aft thrust structure and a forward interstage structure, and further include raceways that extend for a similar length. The reuse hardware includes four landing legs 106 disposed over the thrust structure and a rear portion of propellant tanks 102, as well as four grid fins 108 located on the interstage structure. Thirteen launch vehicle engines are mounted upon the rear of the thrust structure, such that nine are mounted within a circumference substantially defined by propellant tanks 102 and the remaining four are mounted without that circumference upon protuberances shared with landing legs 106. The expendable second stage includes propellant tanks 104, a payload adapter covered by payload fairings, as well as one additional engine that sits within the interstage structure while the first and second stages are connected together. In other embodiments, the number of landing legs 106, grid fins 108, and engines may vary. Further, the shape and configuration of each such element may vary; for example the landing legs may be longer or shorter, the grid fins may instead be planar fins or other control surfaces, and the engine nozzles may be wider or narrower. The techniques introduced herein can be practiced with many variations of launch vehicle 100.

### Landing Leg Systems

A typical launch vehicle launch unfolds in a series of meticulously orchestrated stages, commencing with liftoff when the first stage's engines ignite, propelling the vehicle away from the launch pad and accelerating it through Earth's atmosphere. During this initial ascent, the launch vehicle encounters a critical phase known as maximum dynamic pressure (Max-Q), which signifies the point of peak aerodynamic stress on the vehicle. This is a notable moment, as the launch vehicle is configured to withstand substantial forces while maintaining structural integrity. As the first stage approaches its cutoff point, it has already achieved a substantial fraction of the velocity sufficient to reach orbit. At this stage, the flight control computer issues a command to shut down the engines of the first stage, marking the end of its primary propulsion phase. Following the engine shutdown, the vehicle executes a precise stage separation maneuver, allowing the second stage to ignite and continue its journey into space while the first stage transitions to its recovery phase.

In configurations designed for reuse, the recovery of the first stage initiates almost immediately after separation. Depending on the specific mission profile, the booster may perform a controlled maneuver, commonly referred to as a “boostback burn,” to modify its trajectory and guide it back to a predetermined landing site, such as a land-based platform or a maritime drone ship stationed in the ocean. As the launch vehicle descends, it encounters atmospheric drag, which plays a substantial role in its deceleration. The guidance system may also engage in a reentry burn, where the engines ignite briefly to further reduce velocity and manage the intense heating generated during reentry into the atmosphere.

As the booster approaches the sea or ground, it performs a final landing burn or throttle adjustment, which carefully reduces its speed for a soft touchdown. Deployable landing legs or other stabilization mechanisms are deployed just before contact to ensure that the stage can land upright and remain stable upon arrival. If all systems operate as intended, the launch vehicle's first stage will be successfully recovered intact, allowing for refurbishment and refight for future missions.

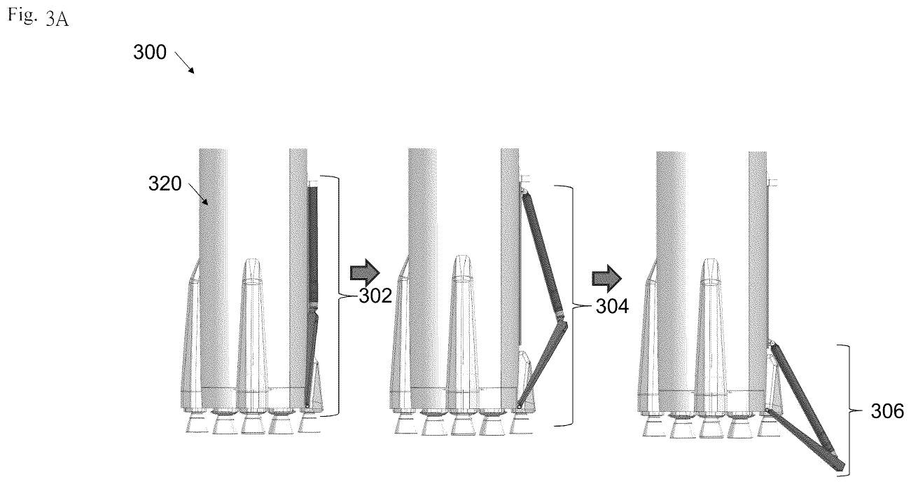

FIG. 2 illustrates a flight segment sequence 200 for a reusable launch vehicle's first stage flight, highlighting the principal flight segments. In many embodiments, the launch vehicle's first stage flight profile 200 can be divided into several principal segments namely: ascent 202, separation 204, re-entry maneuver 206, reentry burn 208, reentry 210, leg deployment 212, and landing 214.

### Ascent 202

The launch vehicle's flight begins with ignition of the first stage engines and a rapid climb through the atmosphere. During this phase, the vehicle experiences maximum dynamic pressure (Max-Q). As the target velocity nears, the flight computer readies the stage for engine cutoff.

### Separation 204

After main engine cutoff (MECO), the first stage detaches from the upper stage, which continues carrying the payload toward its intended orbit. The separated booster then transitions to its reusability operations, using trajectory or propulsive maneuvers to return to a designated landing zone.

### Re-entry Maneuver 206

Depending on mission requirements and the planned landing site, such as a ground-based pad or a drone ship at sea, the first stage may perform a boostback burn or course-correction maneuvers. These maneuvers adjust the first stage's orientation and trajectory to steer the booster, altering its path for proper alignment during atmospheric reentry.

### Reentry Burn 208

As the booster nears Earth's atmosphere, it begins a reentry burn. The booster engine firing decrease velocity and thereby reduces excessive aerodynamic heating.

### Reentry 210

During the reentry segment, the booster now passes through the thickening atmosphere as it descends toward Earth. Aerodynamic surfaces such as grid fins, guide reentry, and control the decent trajectory and orientation to maintain stability and control, managing heat loads and deceleration, which are useful for ensuring the booster remains intact and on course to the landing zone.

### Leg Deployment 212

Once the booster has descended through a substantial portion of the atmosphere and is within range of its targeted landing site, its landing legs are configured to be deployed. In some designs, the legs may extend via pneumatic or electric mechanisms; in others, they can deploy passively, relying chiefly on inertial or aerodynamic forces. Proper timing and a robust locking mechanism ensure the legs are ready for touchdown.

### Landing 214

In the final seconds of flight, the booster executes a controlled landing burn, using one or more engines to slow to a safe descent rate. Touchdown occurs on a designated pad or ship, with the extended legs supporting the launch vehicle's weight and stabilizing it in an upright position. Once landed, the stage can be secured, inspected, and refurbished for reuse in subsequent missions.

In many launch vehicle designs, landing legs are actuated by either pneumatic (gas-pressure-driven) or electric systems. Pneumatic systems draw on high-pressure gas such as gas stored in pressure vessels or extra propellant carried onboard to drive pistons or rams that push the legs into place. Electric systems use motors or linear actuators powered by onboard energy systems such as batteries or the vehicle's main power bus. Both approaches can effectively deploy the legs; each component of the landing system is configured to be carefully integrated into the launch vehicle's overall design.

In accordance with many embodiments, a passive landing leg configuration can allow the landing legs to deploy without being moved primarily by stored energy mechanisms of the landing leg configuration. In many embodiments, the passive landing legs rely primarily on gravity, aerodynamic forces, or accelerations along or around the launch vehicle's axes during descent to guide the legs from their stowed position into a locked, extended stance. In accordance with many embodiments, such configurations eliminate the reliance on additional actuators or pressurized gas. In many embodiments, the landing system lowers the system mass compared to alternative designs. In many embodiments, passive landing legs reduce the number of components susceptible to failure.

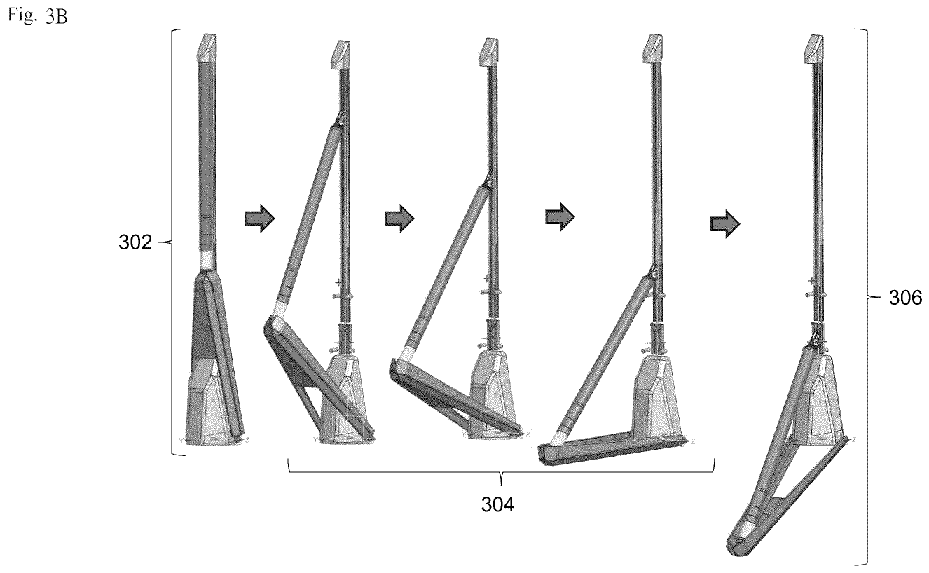

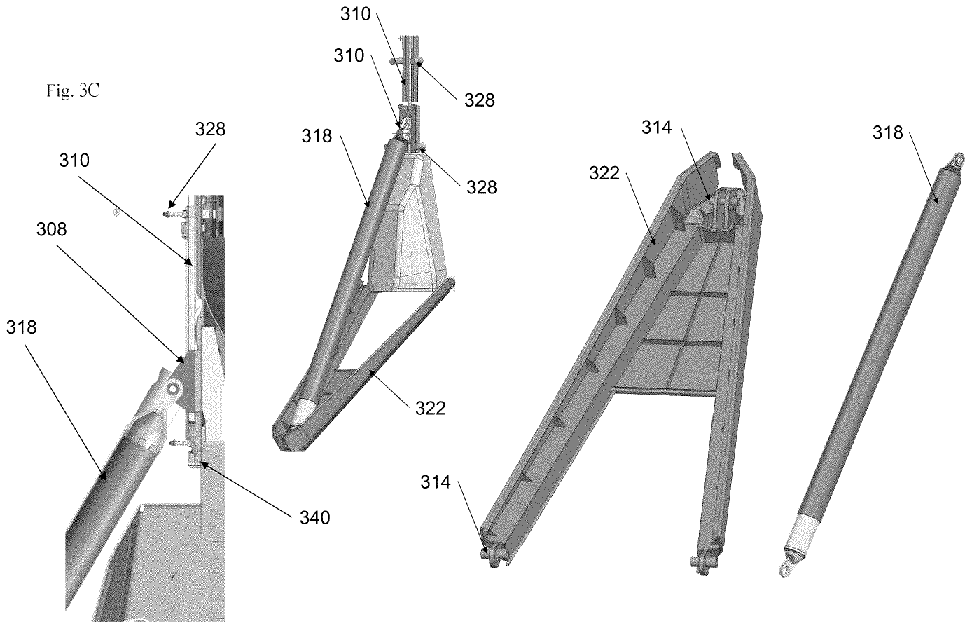

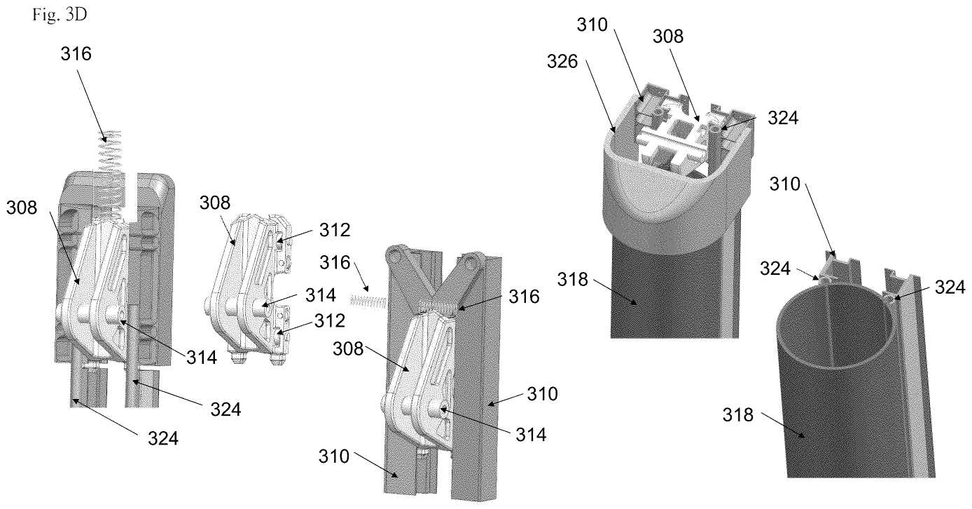

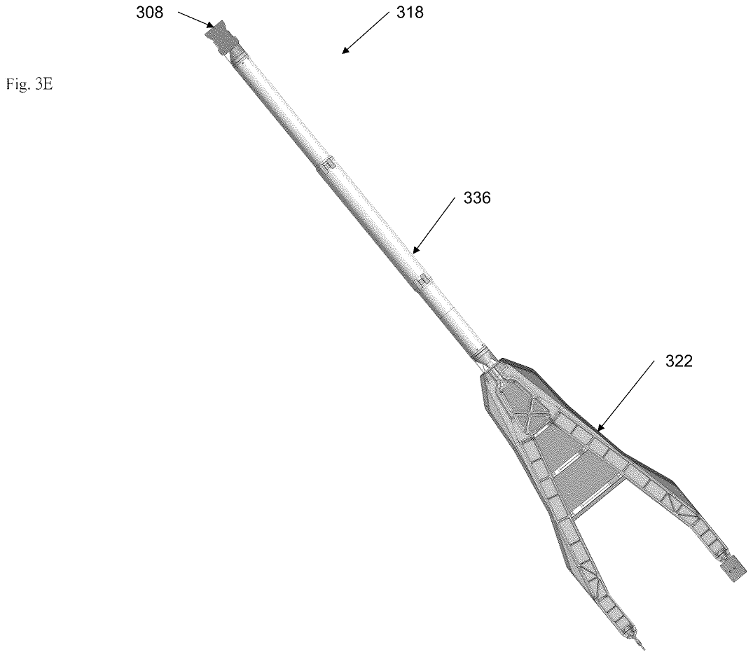

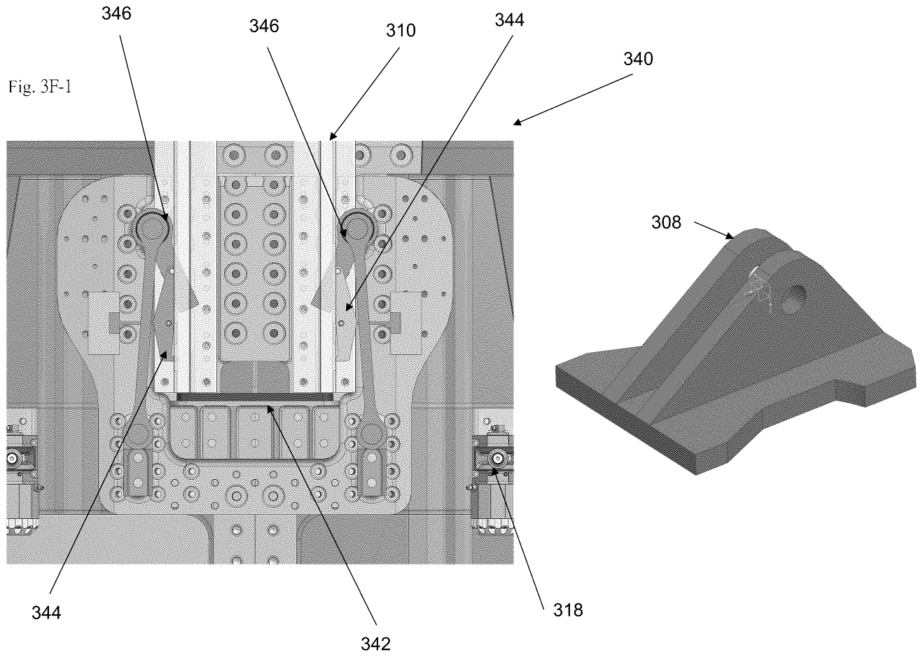

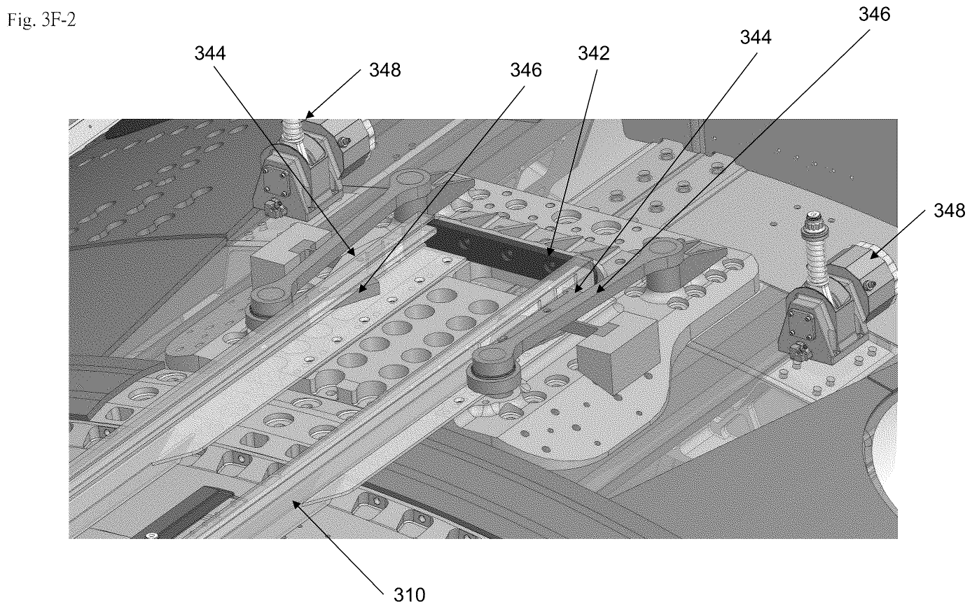

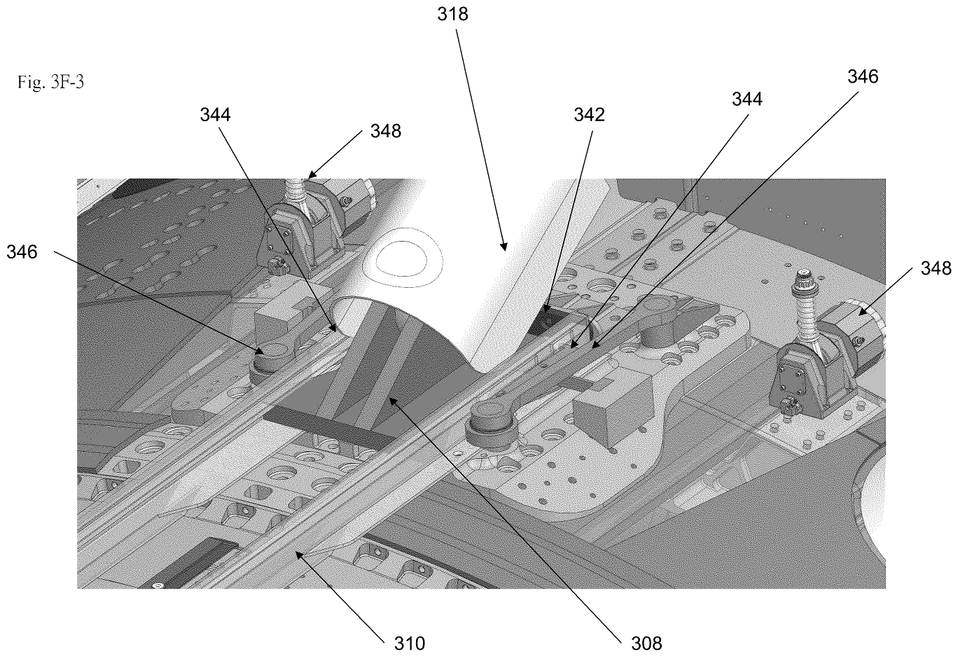

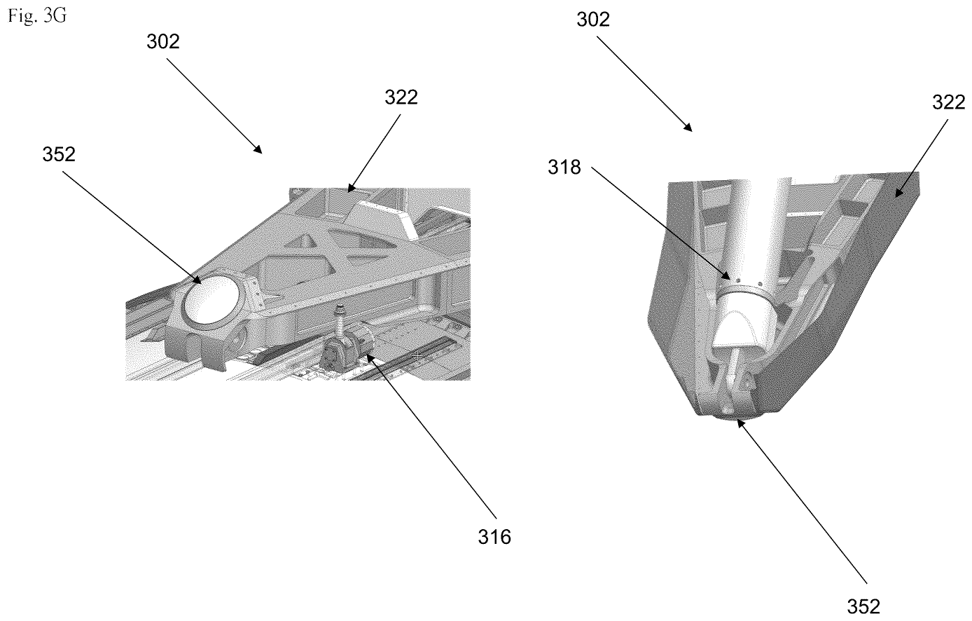

FIGS. 3A and 3B illustrate the deployment of a passive landing system 300 in accordance with many embodiments. The passive landing system 300 transitions from a stowed configuration 302, to a transition configuration 304, to a deployed configuration 306. In accordance with many embodiments, the landing legs of passive landing system 300 are configured for passive deployment. In many embodiments, the landing legs rely on gravity, aerodynamic forces, or the launch vehicle's own motion and inertia during descent to transition the legs from their stowed position 302 into an extended stance. In many embodiments, the landing legs lock into a deployed configuration 306 when fully extended. In many embodiments, the passive landing leg configuration eliminates the reliance on pneumatic or electric actuators to transition the landing legs through a large part or even their full range of motion, or even eliminates their use altogether. In many embodiments, the passive land leg configuration reduces the overall mass of the landing system compared to conventional designs. In many embodiments, the number of components compared to conventional design, is likewise minimized, which subsequently reduces the number of elements susceptible to mechanical or electrical failure.

FIGS. 3C and 3D provide close-up views of the passive landing system 300 components in accordance with many embodiments. In many embodiments, the landing legs incorporate a slide mechanism. In many embodiments, the slide mechanism 308 guides the landing leg motion under dynamic flight conditions. In many embodiments, the slide 308 is configured to traverse a track 310 element. In many embodiments, the slide mechanisms are configured with elements to prevent the slide 308 from binding in the track 310, such as a low-friction bearing 312 or blocks. In many embodiments, the slide 308 and track 310 are configured to transition from a stowed position 302 to a deployed position 306 reliably. In many embodiments, the slide 308 and track 310 are configured to transition without pneumatics or electric actuators.

In many embodiments, the landing legs incorporate pivot points 314. In many such embodiments the pivot points 314 are positioned to facilitate a smooth, predictable swing and actuation of the landing legs. In many embodiments the landing legs are configured with a pivot geometry and load distribution that minimizes binding and excess friction between slides 308, track 310, as well as between other components, during rapid deceleration or exposure to aerodynamic forces.

In many embodiments, the landing legs fall into position and lock, for example under the force of gravity or in response to deceleration or turning of the launch vehicle body 320, without relying on additional powered systems. Such embodiments can nonetheless optionally rely on a biasing mechanism 316 such as a spring that exerts a force on the slide 308 to initiate its motion along the track 310. In some embodiments, the biasing mechanism 316 imparts a force on a linkage 318 outward from the launch vehicle body 320, while in other embodiments the biasing mechanism 316 imparts a force on a linkage 318 downward along the launch vehicle body 320. In all such embodiments, after the biasing mechanism 316 initiates motion within passive landing system 300, the motion completes itself to result in deployed position 306 without the operation of additional powered systems specific to passive landing system 300. Of course, during the time passive landing system 300 is in motion other powered systems of the vehicle, such as its engines or reaction control systems, may still operate; in some embodiments these other powered systems may contribute to the continued motion within passive landing system 300, for example by decelerating launch vehicle body 320 or rotating launch vehicle body 320.

In many embodiments, a hold down release mechanism 328 selectively couples to the landing leg of passive landing system 300. In many such embodiments, when the hold down release mechanism 328 is coupled to the landing leg, the movement of the landing leg is constrained. In many embodiments, the hold down release mechanism 328 secures the landing leg in a stowed configuration 302. In many embodiments, while the hold down release mechanism 328 is coupled, the hold down release mechanism 328 overcomes the force exerted by the biasing mechanism 316. In many embodiments, when the hold down release mechanism 328 is decoupled, the force exerted by the biasing mechanism 316 initiates the landing leg motion. In many embodiments, the slide 308 is pivotally connected to the linkage 318. In many embodiments, the linkage 318 is pivotally connected to a landing foot 322. In many embodiments, the landing foot 322 is pivotally connected to the launch vehicle body 320 at pivot points. In many embodiments, when the landing legs are in a stowed configuration 302, seals 324 are compressed against the linkage 318. In some embodiments, the seals 324 are disposed between the linkage 318 and the track 310. In many embodiments, the seals 324 are configured for aerodynamic performance. In many embodiments, the landing legs incorporate shrouds 326. In many embodiments, the shroud is configured to augment the aerodynamics of the landing legs. Further, in many embodiments one or both of landing foot 322 and linkage 318 is configured to augment the launch vehicle aerodynamics. For example, the length of one or both of landing foot 322 and linkage 318 along launch vehicle body 320 may be sufficient to serve as aerostrake features to improve the maneuvering characteristics of the vehicle. In many embodiments, when deployed, the slide 308 descends the track 310 to a catch mechanism 340. The catch mechanism can be configured to absorb the impact of the slide 308 deployment.

In some embodiments, the linkage 318 incorporates a crush core 336, as shown in FIG. 3E. The crush core 336 can be configured to absorb the force of impact when the landing leg is deployed. The linkage 318 can be configured to house the crush core 336. In some embodiments, the linkage 318 can comprise an outer sleeve configured to slide along the crush core 336. For example, when the landing leg is deployed the outer sleeve of the linkage 318 can compress the crush core 336 such that the force exerted on the vehicle is reduced. In some embodiments, the crush core 336 can be positioned at approximately the midsection of the linkage 318. Positioning the crush core 336 in approximately the midpoint of the length of the linkage 318 can increase the strength of the crush core 336 as compared to a crush core 336 positioned at either end of the linkage 318. It should be understood the crush core 336 can be incorporated in a passive landing legs system or an active landing legs system.

In some embodiments, the landing leg system can incorporate a catch mechanism at the base of the track. FIGS. 3F-1 to 3F-3 provide examples of a catch mechanism 340 in accordance with various embodiments. The catch mechanism can incorporate a shock absorber 342 at the base of the track 310. The shock absorber 342 can be configured to compress and absorb the force of impact of the slide 308. In some embodiments, the size of the shock absorber 342 is based on the size of the slide 308 and/or the length of the track 310. In many embodiments the catch mechanism incorporates a locking mechanism to prevent the slide 308 from ascending the track 310. When the slide 308 enters the catch mechanism, locking arms 344 are extended into the track 310. The locking arms 344 enter a notched region of the slide 308 walls to prevent the slide 308 from passing the locking arms 344. In many embodiments the locking arms 344 are extended by the movement of the lever arms 346. As the slide 308 enters the catch mechanism, the lever arms 346 are pushed out of the track 310 and rotate the locking arms 344 into the track. In some embodiments, the catch mechanism incorporates a release mechanism 348 to unlock the slide 308. The release mechanism may be a biasing mechanism such as a spring that exerts a force on the lever arms 346 to retract the lock arms 344 from the track 310. It should be understood the catch mechanism 340 can be incorporated in a passive landing legs system or an active landing legs system.

In many embodiments, landing leg systems can incorporate a landing footpad. The landing footpad is adjacent to the end of the landing foot, such that when deployed, the landing footpad in in contact with the landing surface. In some embodiments, the landing surface is the ground, a building, a landing pad, and/or a ship. FIG. 3G provides the landing leg system incorporating a footpad. In the stowed position 302, the landing footpad 352 is exposed and near the biasing mechanism 316. The landing footpad 352 is attached to the distal end of the landing foot 322. In the deployed position 306, the landing foot 322 is extended such that the landing footpad 352 is adjacent to the ground. The landing footpad 352 is attached to the opposite side of the landing foot 322 where the linkage 318 is attached to the landing foot 322. It should be understood the landing footpad 352 can be incorporated in a passive landing legs system or an active landing legs system.

Various embodiments are directed to active landing leg systems. In certain embodiments, one or more landing leg systems can incorporate an active application of energy to the deployment, braking, and/or retraction of a landing leg. In some embodiments, active landing legs can include an actuator or a motor to provide external energy to the landing leg system to modulate the deployment of the landing leg. For example, an active landing leg actuator can initiate the deployment of the landing leg and/or slow the deployment of the landing leg during braking. External energy can be applied to the landing legs system to initiate deployment of the landing leg. In several embodiments, the application of external energy initiates the motion of the landing leg by releasing the landing leg system from its stowed position. Active landing legs can initiate motion of the landing leg such that, after the initial movement, the landing leg is deployed passively as described herein. The application of external energy can also be applied at the end of deployment as a braking mechanism to slow deployment of the landing leg. Slowing the deployment of the landing leg can reduce jarring of the vehicle upon landing by activating a brake to the landing leg deployment. In some embodiments, the actuator can be powered by a battery. In certain embodiments, the actuator can be configured to transform the kinetic energy from the motion of the landing leg into energy stored within the battery.

In some embodiments, two or more actuators and/or motors are placed near the base of the landing leg food. For example, the two or more actuators may be positioned at adjacent corners of the landing leg foot near the body of the vehicle. In many embodiments, the two or more actuators are positioned within the landing leg system such that both sides of the landing leg foot are balanced. By balancing the two or more actuators, the force applied to the landing leg system can be evenly distributed. The balanced actuators can also provide even weight distribution throughout the landing leg system.

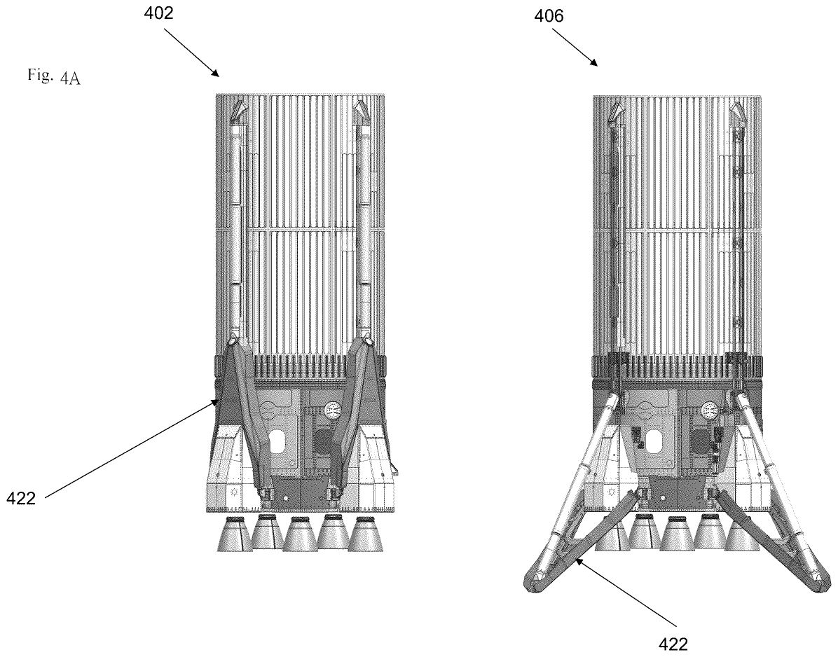

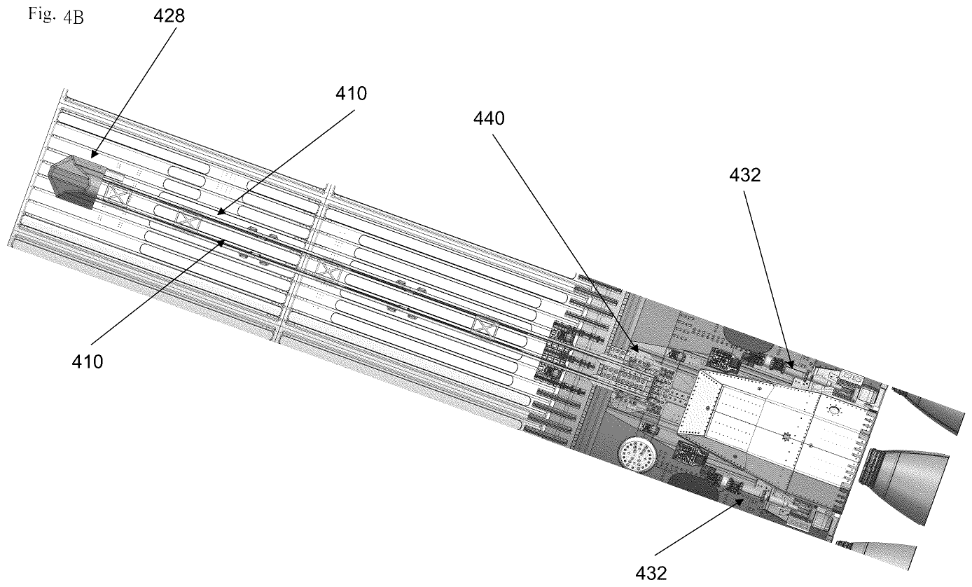

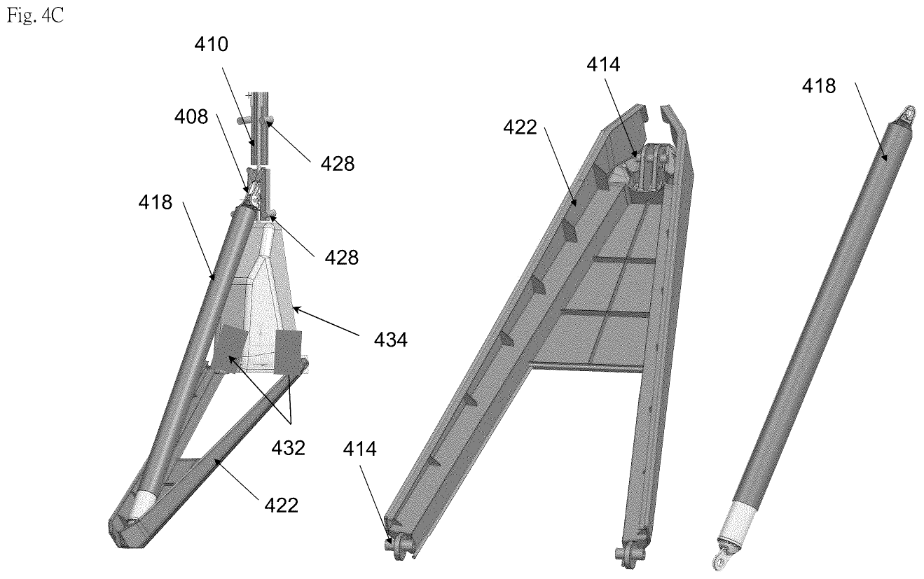

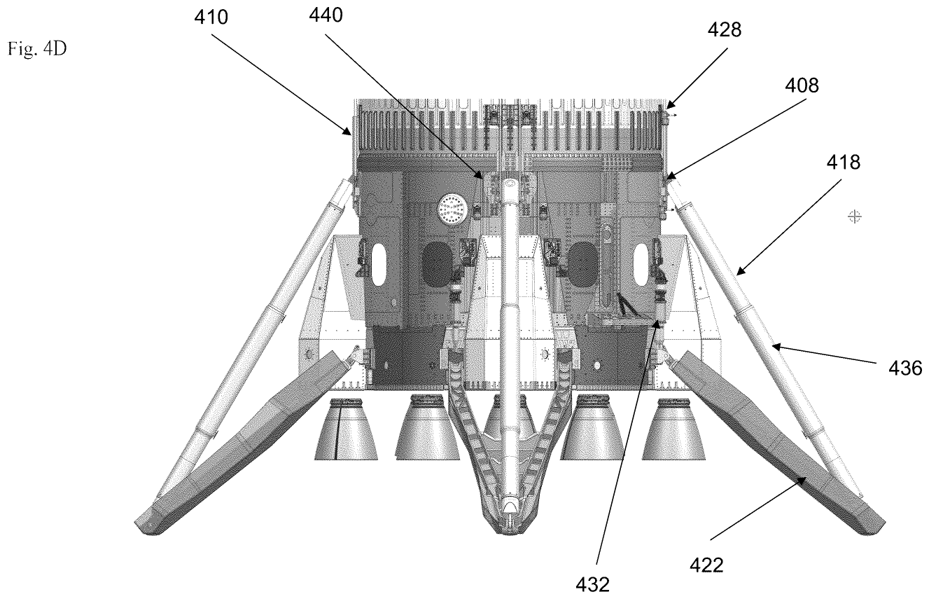

FIG. 4A provides an example of an active landing leg system in a stowed 402 and a deployed 406 configuration. In the stowed position 402 the landing foot 422 is close to the vehicle body. In the deployed position 406 the landing foot 422 is extended below the vehicle body.

FIGS. 4B to 4D provide examples of active landing leg systems in accordance with several embodiments. The landing legs incorporate a sliding mechanism 408. In many embodiments, the sliding mechanism 408 guides the landing leg motion under dynamic flight conditions. The slides 408 are configured to traverse a track element 410. In several embodiments, the slides 408 are configured with elements to prevent the slide 408 from binding in the track 410, such as a low-friction bearing 412 or blocks. The slides 408 and track 410 can be configured to transition from a stowed position to a deployed position reliably. In many embodiments, the slide 408 and track 410 are configured to transition according to a motor and/or actuator. The actuator 432 can be configured to provide an initial energy to the release mechanism 428 to release the slide 408 such that the slide 408 descends the track 410. The actuator 432 can be configured to apply a brake to slow the descent of the slide 408 to reduce the impact of the slide 408 entering the catch mechanism 440.

The landing legs can incorporate pivot points 414. In many such embodiments the pivot points 414 are positioned to facilitate a smooth, predictable swing and actuation of the landing legs. In some embodiments, the landing legs are configured with a pivot geometry and load distribution that minimizes binding and excess friction between slides 408, track 410, as well as other components, during rapid deceleration or exposure to aerodynamic forces. In several embodiments, an actuator 432 is placed near each pivot point 414 to facilitate movement of the landing leg. Each actuator 432 is positioned near each pivot point 414 to provide balance to the landing legs. In many embodiments an actuator 432 is positioned at a pivot point 414 in connection with the base 434 of the landing leg mechanism. In some embodiments, each actuator 432 can shorten during deployment of the landing legs, pulling up on a bar on one side of a pivot point 414, so that the landing leg on the opposite side of the pivot point is pushed down, rotating landing foot 422 lower which then pulls a linkage 418 lower as well.

In many embodiments a linkage 418 connects the landing leg to the slide 408. The linkage 418 can be in connection with the slide 408 such that as the slide 408 descends the track 410, the linkage 418 pivots with respect to the slide 408. In some embodiments, the linkage 418 can be in connection with the landing leg at a pivot point 414 of the landing leg distal to the base 434 of the landing leg mechanism such that as the landing leg descends the linkage 418 pivots with respect to the landing foot 422.

### Pressurizing Propellant Tanks

A launch vehicle benefits from a reliable method to maintain pressure in its propellant tanks. Propellant tanks typically contain a fuel and an oxidizer, each in a separate tank. Among the more widely used launch vehicle fuels are kerosene (RP-1), liquid hydrogen (LH₂), and liquid methane (LNG or CH₄), which are frequently paired with the oxidizer liquid oxygen (LOX). As propellant is consumed during flight, the pressure in the tanks decreases, which can cause the tank to lose structural integrity. In order to maintain structural integrity, the tank can be configured to be pressurized to replace the losses from the spent propellant. One common approach is autogenous pressurization, where the propellant is vaporized and cycled back into the tanks to replace the volume lost from consumption. This method reduces or eliminates the reliance on carrying a separate pressurant gas. However, autogenous pressurization can introduce substantial engineering challenges, particularly the risk of ullage collapse, which occurs when there is a sudden decrease in gas pressure inside the tank due to vapor recondensation. Ullage collapse occurs when the gas-filled space (the ullage) of a propellant tank unexpectedly decreases or “collapses.” This typically occurs if the gas in the ullage, which provides pressure to the tank, cools or condenses back into a liquid. When the gas pressure drops, the internal pressure can fall below the level that is sufficient to keep the tank structurally supported, increasing the risk of damage to the tank structure such as from tank deformation or collapse. In systems that use autogenous pressurization where the tank's own propellant or oxidizer is warmed, converted into gas, and fed back into the tank, the loss of heat or unplanned condensation can lead to rapid ullage pressure decreases and structural failure.

Composite Overwrapped Pressure Vessels (COPVs) are high-strength containers used to store pressurant gases such as helium at very high pressures. Helium is an inert and lightweight gas that does not readily liquefy at cryogenic temperatures. As a pressurant, helium thus bypasses many of the complexities of autogenous systems. By preventing recondensation, utilizing helium substantially reduces the likelihood of ullage collapse. One challenge with utilizing helium, however, lies in how to store helium at extremely high pressures with reduced mass penalty.

When managing high-pressure gases, such as helium stored in a COPV, the gases' thermodynamic behaviors and the effects of the gas expansion and compression impact the design considerations and efficiency of the system. Compression occurs when gas is compressed into a smaller volume. For example, when helium is initially stored in a COPV. Compression results in an increase in the gas temperature. This temperature rises as the result of the gas molecules colliding as they are forced into a constrained space. Conversely, during vehicle operation, when pressurized helium is released from the COPV into a lower-pressure environment, it undergoes rapid expansion. Gas expansion results in cooling, as the gas moves apart, losing internal energy and lowering the temperature. The rate at which gas flows during the gas distribution can greatly influence the temperature changes that result. Rapid compression can lead to significant heating, which can limit the total amount of gas that can be loaded into the COPV as the hotter gas has a greater relative volume and swift expansion can similarly lead to significant cooling effects similarly impacting the gas volume and the efficiency of the system and amount of gas needed to replace the spent fuel.

Fundamentally, the colder the gas can be kept during loading, the more gas that can be loaded, which enhances the effectiveness of the system. Conversely, the hotter the gas can be heated when replacing propellant, the less gas will be needed, further improving the system's efficiency. Additionally, maintaining a low temperature for a COPV and allowing the gas within the COPV sufficient time to stabilize and further cool down can significantly increase the amount of gas that can be loaded into the system. This, in turn, leads to greater overall system efficiency. Consequently, the gases thermal changes throughout all phases needs to factored into the system design; during the initial filling of the COPV, care must be taken to manage the heat generated for effective filling; during storage, where temperatures may gradually stabilize or cool; and during the vehicle's operational phase, when gas is injected into the propellant tanks to sustain pressure.

In accordance with many embodiments, gas such as helium stored in a COPV is released to replace the volume left by consumed propellant. In accordance with many embodiments, the design challenges for storing COPVs are addressed by enclosing the COPVs within the launch vehicle's propellant tanks. In many embodiments, the oxidizer in the oxidizer tank is several degrees colder than the fuel in the fuel tank and the subsequent fuel tank environment. The colder environment of the oxidizer tank enables additional cooling of the COPV gas and more effective system thermodynamics as a result, making placement of the COPV in the oxidizer tank the conventional COPV configuration. In many embodiments, each stage's oxidizer tank has sufficient volume to accommodate COPVs, however, for some launch vehicles and thus some embodiments, there is insufficient volume. In advanced launch vehicles, such as those that utilize LOX and methane, and designed with insufficient oxidizer tank volume to accommodate COPVs, alternative design solutions and configurations are needed.

To overcome space constraints, such as an oxidizer tank that is too compact to hold any COPVs or a sufficient number of COPVs to satisfy a pressurant gas requirement, or such as a propellant (e.g., LOX) tank with a total volume smaller than the minimum volume of propellant (e.g., again, LOX), pressurant (e.g., helium), and pressurant vessels (e.g., helium COPVs) present at a given point in a launch vehicle loading and flight sequence, various embodiments position COPVs in unconventional locations. In many such embodiments, COPVs are disposed within alternative propellant tanks such as the fuel tank. In some embodiments, such as in a launch vehicle configured with a LOX and methane oxidizer and fuel combination, the COPV can be disposed within the fuel tank, as opposed to a more conventional oxidizer tank location. In many embodiments, the COPV configuration maximizes the storage capacity for gases while maintaining the overall functionality and performance of the launch vehicle. In many embodiments, optimizing the integration of COPVs in alternative propellant tanks can meet the COPV storage requirements for the operational integrity of the launch vehicle, while maintaining high efficiency and reliability. In many embodiments, the COPVs further cool during flight. In many such embodiments, pressurant from the COPVs enables gas expansion cooling the COPV. In many embodiments, the COPV attains a lower temperature than the surrounding propellant during flight. In many embodiments where the COPV is disposed in the fuel tank, the minimum temperature attained is higher than the temperature in the oxidizer. In many embodiments, the COPV tank placement is configured for a minimum temperature threshold.

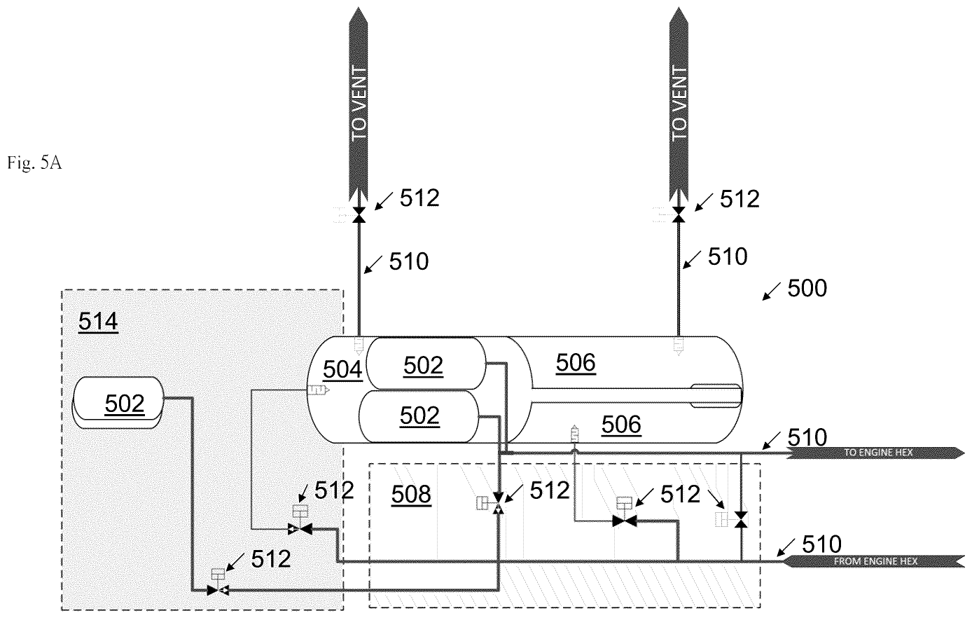

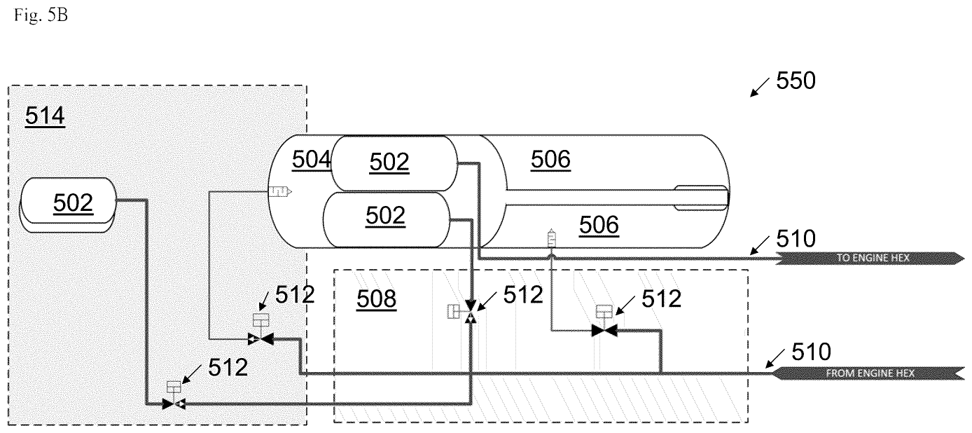

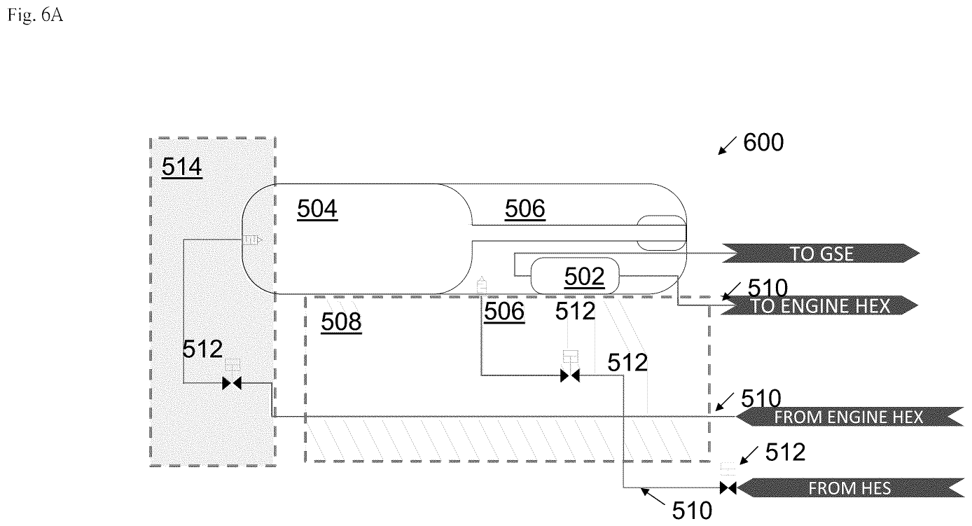

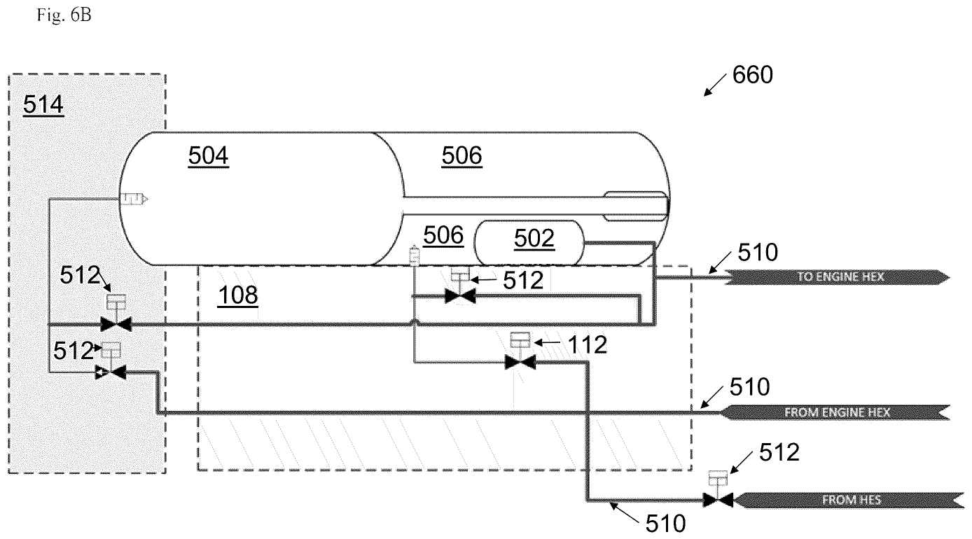

FIGS. 5A to 6B illustrate a schematic of a launch vehicle propellant tank configuration 500, 550, 600, 660 in accordance with many embodiments. FIGS. 5A and 5B schematically illustrate propellant tank configurations 500 and 550 that may be implemented as propellant tanks 102 within the first stage of launch vehicle 100 on FIG. 1. FIGS. 6A and 6B schematically illustrate propellant tank configurations 600 and 660 that may be implemented as propellant tanks 104 within the second stage of launch vehicle 100 on FIG. 1. However, in some embodiments configurations 500 and 550 are implemented within the second stage while configurations 600 and 660 are implemented within the first stage. Alternately, either of propellant tank configurations 500 and 550 may be implemented as both of propellant tanks 102 and 104 in launch vehicle 100. Further alternately, either of propellant tank configurations 600 and 660 may be implemented as both of propellant tanks 102 and 104 in launch vehicle 100. In yet other embodiments, propellant tank configurations described herein can relate to any configuration. In many embodiments, at least one COPV 502 is disposed within a propellant tank 504 and 506 of the configuration 500. In many such embodiments, the propellant cools the COPV 502 and the COPV gas. In many embodiments, the relatively colder propellant and propellant tank 504 and 506 environment can serve as a heat sink for the COPV 102 and contained COPV gas.

In many embodiments, the oxidizer tank 504 and the oxidizer tank environment are colder than the fuel tank 506 and the fuel tank environment. For example, in many embodiments, the liquid oxygen in the oxidizer tank 504 is several degrees colder than the fuel in the fuel tank 506 and the resulting fuel tank environment. In some embodiments, COPV 502 is disposed in the colder oxidizer tank 504. In many such embodiments, the colder environment of the oxidizer tank 504 enables additional cooling of the COPV gas and more effective system thermodynamics. In some embodiments, at least one COPV 502 is located proximal to an oxidizer dome 514 section of the oxidizer tank 504. In many embodiments, the oxidizer dome 514 is located at a distal end of the oxidizer tank 504. In such embodiments, one or more COPVs may be inside the oxidizer tank 504 while one or more additional COPVs are outside the oxidizer tank 504, mounted upon its oxidizer dome 514. In many embodiments, COPV gas from the COPV 502 is distributed through a raceway 508 and a plurality of passageways 510 and valves 512 to the engines. In some embodiments, two or more COPV 502 tanks are fluidly connected by passageways 510 to distribute COPV gas from the COPV 502 to the raceway 508 or the engines. In certain embodiments one COPV 502 tank is fluidly connected by passageways 510 to distribute COPV gas from the COPV 502 to both the raceway 508 and the engines. In many such embodiments, at least one heat exchanger (HEX) thermally coupled with the engines heats the COPV gas before the gas is released into one or both of tanks 504 and 506 to make up for the spent propellant. In many such embodiments, at least one heat exchanger (HEX) thermally coupled with the engine heats only a portion of the COPV gas, while another portion of the COPV gas bypasses the at least one HEX through a passageway 510 and/or valve 512, before the gas is released into one or both of tanks 504 and 506 to make up for the spent propellant. Many embodiments are configured to maximize the heating of the COPV fuel make-up gas for effective system thermodynamics. In many embodiments, the COPV gas is an inert gas such as helium. Helium is inert, light weight, does not recondense into a liquid phase in the manner of autogenous gases such as methane and oxygen.

In some embodiments, the oxidizer tank 504 may be too compact to hold sufficient COPVs 502 for efficient operation. In many embodiments, at least one COPV 502 is disposed in the fuel tank 506. In many embodiments, the heat transfer rates in the fuel tank 506 are lower than the heat transfer rate in the oxidizer tank 504. In such embodiments, at least one COPV 502 may be fitted with dual lines 510, for example as shown in configuration 600, connected to at least one heat exchanger (HEX) and to ground support equipment (GSE) respectively. Accordingly, one line may be used to fill the at least one COPV 502 with cooler helium, while another line, for example at an opposite end of the COPV (e.g., the top end when the vehicle is stacked for launch), may be used to remove warmer helium (e.g., helium that has absorbed heat from the surrounding propellant). In some embodiments, such as in a launch vehicle configured with a LOX and methane oxidizer and fuel combination, the COPV 502 is disposed within the fuel tank 506. In many such embodiments, the COPV 502 is configured to be submerged in methane. In many embodiments, the COPV 502 is configured to withstand, prevent, or minimize chemical reactions in the propellant tank 504 and 506. Methane is susceptible to icing. In many embodiments, system 500, 550, 600, 660 is configured to prevent or minimize icing. In many embodiments, the COPV is configured to minimize the occurrence of icing in the fuel tank 506. In many embodiments, the system 500, 550, 600, 660 is configured to maintain operation in the event of icing. In many embodiments, the COPV is configured to prevent the buildup of icing conditions.

In many embodiments, the oxidizer tank 504 and the fuel tank 506 can be vented, for example as shown in configuration 500. The oxidizer tank 504 and the fuel tank 506 can be connected to valved 512 passageways 510. The oxidizer tank 504 can be vented during conditioning to control temperature. The oxidizer tank 504 can be vented during propellant load to control temperature during loading. The oxidizer tank 504 and/or fuel tank 506 can be vented to control pressurization. The oxidizer tank 504 can be vented during flight and/or landing to maintain proper pressurization. Though only one valve 512 is depicted, it should be understood any number of valves necessary can be incorporated to provide venting of the oxidizer tank 504 and/or fuel tank 506.

### Propellants Characteristics

Saturated, densified, and subcooled propellants are terms that pertain to the various temperature and pressure conditions under which a launch vehicle's fuel or oxidizer is stored. A saturated propellant is maintained at or near its boiling temperature corresponding to the specific storage pressure, resulting in an equilibrium between the liquid and vapor phases. In contrast, densified or subcooled propellants are subjected to cooling below their standard boiling point. This process yields a higher density, which permits the launch vehicle to contain a greater mass of propellant within a given tank volume. The increased density of the liquid phase can improve both thrust and operational range, while also allowing for the possibility of reduced tank sizes or enhanced payload capacity. However, densified or subcooled propellants need to be loaded expeditiously to prevent unnecessary heating and phase change, and propellant loss. Any necessary additional dwell time of the densified or subcooled propellants results in the warmer surrounding environment heat being absorbed by the densified or subcooled propellant, and the propellant off gassing that results in lost propellant. Rapid loading needs to be balanced with the thermodynamics of the system. In various embodiments, the tank design is configured to balance load speed, heating, cooling, COPV gas, oxidizer, and fuel volumes to enhance efficiency and improve system thermodynamics.

In some embodiments, the COPV 502 is submerged in a saturated propellant. In many embodiments, the COPV 502 is configured so that saturated propellant cools the COPV gas in the COPV 502 and as it is loaded through the passageways 510 into the COPV 502 enabling more effective COPV gas loading. In some embodiments, the COPV 502 is configured so that after a dwell time additional gas can be loaded into the COPV 502. In many embodiments, loading the propellants is configured for thermodynamic efficiency. In some such embodiment, propellants are densified. In some such embodiments, the propellants are loaded expeditiously with limited dwell time.

### Vehicle Configuration

In some embodiments, a first stage system is loaded with a first oxidizer at a first oxidizer temperature, and a first fuel at a first fuel temperature, and a second stage system is loaded with a second oxidizer at a second oxidizer temperature, and a second fuel at a second fuel temperature. In many embodiments, the heat transfer rates in the fuel tank are lower than the heat transfer rates in the oxidizer tank.

In particular, a vehicle configuration of several first embodiments includes a first stage with at least at least two propellant tanks 504 and 506, an oxidizer tank 504 and a fuel tank 506, and at least one pressurant COPV 502 inside at least one of the at least two propellant tanks 504 and 506. The instant vehicle configuration further includes a second stage with an oxidizer tank 504 and a fuel tank 506, and includes at least one pressurant COPV 502 inside the fuel tank 506. The second-stage tanks can be of different sizes than the first-stage tanks. In various embodiments while the at least one COPV 502 may fit within the first stage oxidizer tanks 504, the at least one COPV 503 may be unable to fit within the second stage oxidizer tanks 504. In such configurations, the pressurant COPV 502 inside the propellant tanks 504 and 506 can nonetheless share a similar or even identical design, resulting in greater ease of producing large numbers of the design notwithstanding the different oxidizer and fuel environments that may exist within the first and second stage oxidizer tanks. The instant vehicle configuration may also include additional pressurant COPV 502 disposed external to the propellant tanks 504 and 506, for example mounted directly on an exterior surface of a tank dome 514.

In particular, a vehicle configuration in accordance with several additional embodiments includes a first stage with an oxidizer tank 504, a fuel tank 506, and at least one pressurant COPV 502 inside the oxidizer tank 504. The instant vehicle configuration may further include a second stage with an oxidizer tank 504 and a fuel tank 506, and may include at least one pressurant COPV 502 inside the fuel tank 506. The second-stage tanks can be of different sizes than the first-stage tanks. In various embodiments while the at least one COPV 502 may fit within the first stage oxidizer tanks, the at least one COPV may be unable to fit within the second stage oxidizer tanks. In such configurations, the COPV 502 inside the propellant tanks 504 and 506 may nonetheless share a similar or even identical design, resulting in greater ease of producing large numbers of the design notwithstanding the different oxidizer and fuel environments each is exposed to. The instant vehicle configuration may include an additional pressurant COPV 502 outside any of its propellant tanks 504 and 506, for example mounted directly on an exterior surface of a tank dome 514.

Further, a vehicle configuration of several third embodiments includes a first stage with a liquid oxygen tank 504 and a liquid methane tank 506, and includes at least one helium COPV 502 inside the liquid oxygen tank 504. The instant vehicle configuration further includes a second stage with a liquid oxygen tank 504 and a liquid methane tank 506, and includes at least one COPV inside the liquid methane tank 506. The first-stage liquid oxygen may be −295° F. (saturated) while the first-stage liquid methane may be −280° F. (subcooled). Further, the second-stage liquid oxygen may be −310° F. (subcooled) while the second-stage liquid methane may be −280° F. (subcooled). The second-stage tanks can be of different size than the first-stage tanks, in particular such that although helium COPVs 502 can fit within the first stage liquid oxygen tank 504, they cannot fit within the second stage liquid oxygen tank 504. In such configuration, the helium COPV 502 inside the propellant tanks 504 and 506 can nonetheless share a similar or even identical design, resulting in greater ease of producing large numbers of the design notwithstanding the different liquid oxygen and liquid methane environments that may exist within the propellant tanks. The instant vehicle configuration may include additional helium COPVs 502 disposed external to its tanks, for example mounted directly on an exterior surface of a tank dome 514.

### Doctrine Of Equivalents

This description of the disclosure has been presented for the purposes of illustration and description. It is not intended to be exhaustive or to limit the disclosure to the precise form described, and many modifications and variations are possible in light of the teaching above. The embodiments were chosen and described in order to better explain the principles of the disclosure and its practical applications. This description will enable others skilled in the art to better utilize and practice the disclosure in various embodiments and with various modifications as are suited to a particular use. The scope of the disclosure is defined by the following claims.

As used herein, the singular terms “a,” “an,” and “the,” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. Where ranges are described, the range should be understood to include the endpoints of the ranges, and the endpoints of such ranges are also contemplated to stand on their own as inventive, individual data points and to form the endpoints of other ranges. For example, a ratio in the range of about 1 to about 200 should be understood to include the explicitly recited limits of about 1 and about 200, but also to include individual ratios such as about 2, about 3, and about 4, sub-ranges such as about 1 to about 10, about 10 to about 50, about 20 to about 100, about 100 to about 200, and so forth, and related ranges such as greater than about 1 or less than about 200.

What is claimed is:

1. A launch vehicle storage system comprising:
a plurality of propellant tanks;
at least one pressurant tank disposed within one of the plurality of propellant tanks;
a plurality of fluid passageways interconnecting the plurality of propellant tanks and the at least one pressurant tank;
wherein at least one propellant tank is an oxidizer tank and at least one propellant tank is a fuel tank, and at least one pressurant tank is disposed within the fuel tank; and
wherein a fuel tank and the pressurant tank are configured so that a fuel disposed in the fuel tank transfers heat from the pressurant tank.

2. The launch vehicle storage system of claim 1 further configured so that the heat transferred from the pressurant tank cools a pressurant disposed in the pressurant tank.

3. The launch vehicle storage system of claim 1 further comprising a plurality of valves in fluid communication with the plurality of fluid passageways and configured to distribute a pressurant from the pressurant tank proximal to a heat source heating the pressurant.

4. The launch vehicle storage system of claim 3 wherein the pressurant is distributed to at least one of the plurality of propellant tanks.

5. The launch vehicle storage system of claim 1 wherein the fuel is a cryogenic fuel.

6. The launch vehicle storage system of claim 1 wherein the fuel is saturated or densified.

7. The launch vehicle storage system of claim 1 wherein an oxidizer disposed in the oxidizer tank is saturated or densified.

8. A method for fueling a launch vehicle storage system comprising:
loading propellants into a launch vehicle storage system;
wherein the launch vehicle storage system comprises a plurality of propellant tanks, at least one pressurant tank disposed within one of the plurality of propellant tanks, and a plurality of fluid passageways interconnecting the plurality of propellant tanks and the at least one pressurant tank;
wherein at least one propellant tank is an oxidizer tank, at least one propellant tank is a fuel tank, and at least one pressurant tank is disposed within the fuel tank such that when a fuel is disposed in the fuel tank the fuel transfers heat from the pressurant tank;
introducing an oxidizer into the oxidizer tank;
introducing a pressurant into the pressurant tank;
introducing a fuel into the fuel tank so that the at least one pressurant tank is surrounded by the fuel allowing the fuel to absorb thermal energy from the at least one pressurant tank and thereby regulating the temperature within the pressurant tank; and
distributing the pressurant between the propellant tanks and the pressurant tank via the plurality of fluid passageways for launch vehicle operation.

9. A method for fueling a launch vehicle storage system, comprising:
loading a first stage system with a first oxidizer at a first oxidizer temperature and a first fuel at a first fuel temperature;
loading a second stage system with a second oxidizer at a second oxidizer temperature and a second fuel at a second fuel temperature;
wherein the first stage system comprises a plurality of first stage propellant tanks and at least one first stage pressurant tank disposed within one of the plurality of propellant tanks;
wherein the second stage system comprises a plurality of second stage propellant tanks, at least one second stage pressurant tank disposed within one of the plurality of propellant tanks, and a plurality of fluid passageways interconnecting the plurality of second stage propellant tanks and the at least one second stage pressurant tank;
wherein at least one second stage propellant tank is an oxidizer tank, at least one second stage propellant tank is a fuel tank, and the at least one second stage pressurant tank is disposed within the fuel tank such that the fuel transfers heat from the pressurant tank;
introducing the first oxidizer and the second oxidizer into the oxidizer tanks; and
introducing the first fuel and the second fuel into the fuel tanks so that the at least one second stage pressurant tank is surrounded by the fuel in at least one of the second stage fuel tanks.

10. The method for fueling a launch vehicle storage system of claim 9, wherein a heat transfer rate in the fuel tank is lower than a heat transfer rate in the oxidizer tank.

11. A launch vehicle storage system comprising:
a plurality of propellant tanks;
a plurality of pressurant tanks disposed within at least two of the plurality of propellant tanks;
a plurality of fluid passageways interconnecting the plurality of propellant tanks and the plurality of pressurant tanks;
wherein at least one propellant tank is an oxidizer tank and at least one propellant tank is a fuel tank, and at least one pressurant tank is disposed within the oxidizer tank, and at least one pressurant tank is disposed within the fuel tank;
wherein the oxidizer tank and the pressurant tank within the oxidizer tank are configured so that an oxidizer disposed in the oxidizer tank transfers heat from the pressurant tank. and
wherein the fuel tank and the pressurant tank within the fuel tank are configured so that a fuel disposed in the fuel tank transfers heat from the pressurant tank.

12. A launch vehicle landing system comprising:
a plurality of landing legs disposed on a launch vehicle body configured to transition from a stowed configuration to a deployed configuration;
wherein each of the plurality of landing legs is configured to extend distally from an axis of the launch vehicle body;
wherein each of the plurality of landing legs comprises a slide, a track, a linkage, a landing foot, a plurality of pivot points and a biasing mechanism;
wherein the at least one biasing mechanism is configured to exert a force on at least one of the plurality of landing legs;
wherein the slide is configured to traverse from a first end of the track to a second end of the track;
wherein the slide mechanism is pivotally coupled to the linkage, the linkage is pivotally coupled to the landing foot and the landing foot is pivotally coupled to the launch vehicle body and traversing the slide mechanism from the first end of the track to the second end of the track transitions the plurality of landing leg from the stowed configuration to the deployed configuration;
wherein the linkage and landing foot pivot at pivot points disposed on the slide mechanism and the launch vehicle body.

13. The launch vehicle landing system of claim 12, wherein in the deployed configuration a catch mechanism secures the plurality of landing legs in an orientation.

14. The launch vehicle landing system of claim 12, wherein the slide mechanism further comprises a low-friction bearing or blocks.

15. The launch vehicle landing system of claim 14, wherein the low-friction bearing or blocks comprise bearings.

16. The launch vehicle landing system of claim 12, further comprising at least one seal disposed proximal to the linkage.

17. The launch vehicle landing system of claim 12, further comprising at least one shroud disposed proximal to each of the plurality of landing legs.

18. The launch vehicle landing system of claim 17, wherein the at least one shroud is configured to augment each of the landing legs aerodynamics.

19. The launch vehicle landing system of claim 12, wherein the linkage is configured to augment aerodynamics of the launch vehicle body.

20. A method of deploying a landing system comprising:
releasing a plurality of landing legs disposed on a launch vehicle body, the plurality of landing legs each comprising a slide, a track, a linkage, a landing foot, a plurality of pivot points, at least one hold down release mechanism and at least one biasing mechanism;
wherein releasing the plurality of landing legs induces the at least one biasing mechanism to exert a force on each of the plurality of landing legs;
extending the plurality of landing leg distal from the launch vehicle body;
sliding the slide from a first end of the track to a second end of the track;
pivoting the linkage and landing foot at pivot points relative to the slide and the launch vehicle body;
transitioning the plurality of landing legs from a stowed position to a deployed position;
wherein the slide is pivotally coupled to the linkage, the linkage is pivotally coupled to the landing foot and the landing foot is pivotally coupled to the launch vehicle body and traversing the slide from the first end of the track to the second end of the track transitions the plurality of landing leg from the stowed position to the deployed position; and
locking the plurality of legs in the deployed position.
